(19) United States
(12) Patent Application Publication
(10) Pub. No.: US 2024/0303573 A1
(43) Pub. Date: Sep. 12, 2024

(54) INTELLIGENT WORKFLOW FOR MATURITY ASSESSMENT OF ECOSYSTEM-ENABLED INNOVATION

(71) Applicant: INTERNATIONAL BUSINESS MACHINES CORPORATION, Armonk, NY (US)

(72) Inventors: Lisa FISHER, Johannesburg (ZA); Jacob DENCIK, Brussels (BE); Anthony LIPP DE FAOITE, New York City, NY (US); Anthony MARSHALL, Jersey City, NJ (US); Sarah Diane GREEN, Chandler, AZ (US); Analese LUTZ, Ann Arbor, MI (US)

(21) Appl. No.: 18/178,972

(22) Filed: Mar. 6, 2023

(51) Int. Cl. G06Q 10/0637; G06F 16/242

(52) U.S. Cl. CPC G06Q 10/0637; G06F 16/243

(57) ABSTRACT

Computer implemented method, systems, and computer program products include program code executing on a processor(s) generating a data corpus based on discovering data sources accessible to the processor(s), in the ecosystem. Program code analyzes data comprising the data corpus to identify key parameters defining maturity and performance of a pre-defined level of efficiency. Program code generates a model to evaluate the open innovation maturity and the performance of the systems and the processes utilized by the entity. Program code continuously expands a data footprint of the ecosystem based on accessing additional data sources, wherein expanding the ecosystem provides a portion of data in the additional data sources to the corpus. Program code updates the model to a most current version of the model, based on the expanding. Program code generates a visualization of the open innovation maturity and the performance based on applying the model.

### BACKGROUND

The present invention relates generally to maturity assessments and more specifically to a process and infrastructure for a maturity assessment.

A maturity assessment evaluates the attributes of an organization's processes to determine the process' ability to consistently and continuously contribute to achieving organizational objectives. Processes with a high ability of contributing to these objectives are considered mature. When conducting a maturity assessment, factors evaluated include, but are not limited to, data governance, data capabilities, data availability, and/or data use and impact.

Open innovation promotes a mindset counter to the secrecy and silo mentality of traditional corporate research labs. In open business models, collaboration with partners in the ecosystem becomes a central source of value creation. Companies pursuing an open business model actively search for novel ways of working together with suppliers, customers, or complementors to open and extend their business.

As organizations accelerate their digital transformation initiatives and fundamentally change the way they operate, the changes can be characterized by an increased collaboration at an ecosystem level and the use of more open business models. The use of collaboration and models has affected business processes executed by organizations, including but not limited to, how they innovate, bring new ideas to market, and generate value. Because changes occur over time, it is difficult to understand, at any given time, the open innovation maturity and performance of the processes.

### SUMMARY

Shortcomings of the prior art are overcome, and additional advantages are provided through the provision of a computer-implemented method for automatically generating and implementing a dynamic maturity model to generate a visualization of open innovation maturity and performance of systems and processes utilized by an entity in an ecosystem. The computer-implemented method includes: generating, by one or more processors in the ecosystem, a data corpus based on discovering data sources accessible to the one or more processors, in the ecosystem; analyzing, by the one or more processors, data comprising the data corpus to identify key parameters defining maturity and performance of a pre-defined level of efficiency; generating, by the one more processors, a model to evaluate the open innovation maturity and the performance of the systems and the processes utilized by the entity; continuously expanding, by the one or more processors, a data footprint of the ecosystem based on accessing additional data sources, wherein expanding the ecosystem provides a portion of data in the additional data sources to the corpus; updating, by the one or more processors, the model to a most current version of the model, based on the expanding; and generating, by the one or more processors, a visualization of the open innovation maturity and the performance of the systems and the processes utilized by the entity in an ecosystem based on applying the most current version of the model.

Shortcomings of the prior art are overcome, and additional advantages are provided through the provision of a computer program product for automatically generating and implementing a dynamic maturity model to generate a visualization of open innovation maturity and performance of systems and processes utilized by an entity in an ecosystem. The computer program product comprises a storage medium readable by a one or more processors and storing instructions for execution by the one or more processors for performing a method. The method includes, for instance: generating, by the one or more processors in the ecosystem, a data corpus based on discovering data sources accessible to the one or more processors, in the ecosystem; analyzing, by the one or more processors, data comprising the data corpus to identify key parameters defining maturity and performance of a pre-defined level of efficiency; generating, by the one more processors, a model to evaluate the open innovation maturity and the performance of the systems and the processes utilized by the entity; continuously expanding, by the one or more processors, a data footprint of the ecosystem based on accessing additional data sources, wherein expanding the ecosystem provides a portion of data in the additional data sources to the corpus; updating, by the one or more processors, the model to a most current version of the model, based on the expanding; and generating, by the one or more processors, a visualization of the open innovation maturity and the performance of the systems and the processes utilized by the entity in an ecosystem based on applying the most current version of the model.

Shortcomings of the prior art are overcome, and additional advantages are provided through the provision of a system for automatically generating and implementing a dynamic maturity model to generate a visualization of open innovation maturity and performance of systems and processes utilized by an entity in an ecosystem. The system includes: a memory, one or more processors in communication with the memory, and program instructions executable by the one or more processors via the memory to perform a method. The method includes, for instance: generating, by the one or more processors in the ecosystem, a data corpus based on discovering data sources accessible to the one or more processors, in the ecosystem; analyzing, by the one or more processors, data comprising the data corpus to identify key parameters defining maturity and performance of a pre-defined level of efficiency; generating, by the one more processors, a model to evaluate the open innovation maturity and the performance of the systems and the processes utilized by the entity; continuously expanding, by the one or more processors, a data footprint of the ecosystem based on accessing additional data sources, wherein expanding the ecosystem provides a portion of data in the additional data sources to the corpus; updating, by the one or more processors, the model to a most current version of the model, based on the expanding; and generating, by the one or more processors, a visualization of the open innovation maturity and the performance of the systems and the processes utilized by the entity in an ecosystem based on applying the most current version of the model.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a workflow that illustrates various aspects of some embodiments of the present invention;

FIG. 3 illustrates some aspects of the certain functionalities of various embodiments of the present invention;

FIG. 4 illustrates some aspects of the certain functionalities of various embodiments of the present invention;

FIG. 5 illustrates some aspects of the certain functionalities of various embodiments of the present invention; and

FIG. 6 depicts one example of a machine learning training system used in accordance with one or more aspects of the present invention.

### DETAILED DESCRIPTION

Embodiments of the present invention include a system, method, and computer program product that provide a comprehensive and dynamically updated view of open innovation maturity and performance of systems and processes utilized within entities, including organizations. The examples herein include a system and method of creating and operating an artificial intelligence (AI) driven intelligent workflow for maturity assessment of ecosystem-enabled innovation. The examples herein adjust the view of open innovation maturity to reflect how open innovation capabilities are changing over time, including but not limited to, the extent to which these entities are leveraging new technology and ecosystems to change the way they achieve better innovation and business performance. Embodiments of the present invention utilize innovations, including but not limited to, artificial intelligence (AI), Blockchain and distributed systems, such as cloud computing, to capture, process and analyze data to: 1) continuously adapt and improve a framework; and 2) update parameters and maturity thresholds. Based on updating the framework, program code in embodiments of the present invention can automate recruitment of participants and analysis of parameters. Aspects of the examples described herein can be utilized for maturity models across business domains that are subject to continuous change and disruption. These models can include, but are not limited to, models for sustainability, cyber security, and/or digital transformation.

Embodiments of the present invention are inextricably tied to computing and are directed to a practical application. The examples described herein are inextricably linked to computing as the examples herein provide systems, methods, and computer program products that create and operate an AI-driven intelligent workflow for maturity assessment of ecosystem-enabled innovation to provide a comprehensive, continuously, and dynamically updated view of open innovation maturity and performance. Central to generating the dynamically updated view are computer technologies, including but not limited to AI, Blockchain and distributed systems, such as cloud computing. By utilizing these technologies to gain a better understanding of its processing in its technical environment (e.g., open ecosystem), organizations are provided with the opportunity to assess and benchmark the maturity and performance of their own capabilities against these requirements and provide paths to build or improve open innovation capabilities both for individual companies and/or for clusters of organizations. Embodiments of the present invention dynamically model and assess resources and this dynamic modeling is enabled by a technological backbone, and for at least these reasons, the embodiments described herein are inextricably linked to computing. Furthermore, providing paths to build or improve open innovation capabilities both for individual companies and/or for clusters of organizations is a practical application.

In addition to being inextricably linked to computing, embodiments described herein provide significant advantages over existing approaches for assessing open ecosystem-enabled innovation maturity. One such significant advantage is that while existing approaches are based on static models, embodiments of the present invention provide an open standard model that is dynamic. Existing maturity models for open/ecosystem-enabled innovation are static meaning that they are defined at a point in time and do not allow for continuous updates and improvements. Because these models are static, they cannot provide an up-to-date view of the rapidly changing capabilities (e.g., operational, cultural, technological, etc.) for successful open innovation. Existing static models are not equipped to provide an appropriate path to guide companies in building or improving their open innovation capabilities both now and in future. The dynamic quality of the examples herein are described in greater detail, however, the examples herein include a system, method, and computer program product that continuously, dynamically and iteratively refines and improves maturity model dimensions and parameters and scores and weights questions based on insights from analysis of internal and external data. Program code in embodiments of the present invention identifies parameters of maximum importance for successful open innovation and tracks interdependencies/overlaps and discontinuities to continuously refine and improve assessment and progression criteria. The dynamic model generated and updated by the program code is temporal and sustainable. In some embodiments described herein, the program code reposits data and ensures sustainability of the model and data linkages by creating a distributed (e.g., cloud-based) backup-knowledge repository with self-healing AI capabilities. The self-healing includes the program code of the model mutating algorithms and adjusting roles of parameters in the event of broken links to external data. To enable the dynamic aspects of the examples herein, the examples described herein include certain aspects that are not found in existing (static) approaches, which include: 1) program code (executing on one or more processors) that continuously refines data and the generated model to create iterative improvements and to extend the model; 2) program code that performs continuous sourcing of inputs for expansion; 3) program code that performs real-time (data) validation; 4) program code that dynamically updates, including automatically re-setting baselines; and 5) program code that provides sustainability and/or integrity, backward traceability, and/or comparability. Each of these aspects is described in greater detail below and contrasted with existing approaches.

Program code in embodiments of the present invention provides continuous, iterative improvement, and extension of the model it generates. In existing approaches, the static models rely on dimensions defined at a point in time, based on experience, literature review, proprietary research, subject matter expert (SME) collaboration, and scoring based on presence of foundational elements. Any adaptations and improvements in these existing approaches are entirely manual. In contrast, embodiments of the present invention utilize a variety of statistical methods applied to a corpus of primary and secondary research. These methods, as executed by the program code, based on the program code tracking data interdependencies and/or overlaps as well as discontinuities, inform definition of and, when augmented with external data, continuous refinement and improvement of model dimensions and parameters, scoring and weighting of maturity model questions assessment and progression criteria.

Program code in embodiments of the present invention performs continuous sourcing of inputs for expansion (e.g., of the model and the assessment). While existing approaches generate static models where participants are defined and recruited manually and these approaches may include automated data gathering from primary research and analysis as well as secondary data sources (e.g., a finite, static, resource), in embodiments of the present invention, the foundational data is dynamic. Specifically, in some embodiments of the present invention, the program code continually expands and iterates the data foundation by identifying and recruiting potential participants and/or data sources and connecting to digitized sources to obtain additional data.

Program code in embodiments of the present invention performs real-time (data) validation. To validate data integrated into existing static models, program code can perform limited statistical procedures and/or market-based comparison. In embodiments of the present invention, data can be validated by the program code in real-time (or near real-time) because the program code utilizes validation loops with dynamic smart contracting to govern data flow, including but not limited to: managing how the data are collected and handled, rating respondents, allowing registration, and pausing data ingestion to initiate review cycles. Thus, in real-time, the program code can understand, react to and generate responses if organizational information or data being provided are complete, incomplete and/or biased.

Program code in embodiments of the present invention dynamically updates, including automatically re-setting baselines (e.g., re-baselining). Existing approaches include static models that can only be updated manually. Meanwhile, in embodiments of the present invention, the program code performs dynamic updates to the model(s) it generates and continuously re-baselines the model. The program code can perform these continuous updates according to defined criteria and based on comparison with owned proprietary primary research and analysis, including but not limited to, checks and balances. The program code develops criteria for determining whether a performance level is an innovation, a best practice, and/or an industry standard. The program code compares model and corpus data with other owned proprietary primary research and analysis. Based on performing this analysis, the program code can promote based on level of adoption and adjust scoring of parameters according to changes in role. When the program code determines that a sufficient weight of changes has been achieved, the program code establishes a new baseline.

Program code in embodiments of the present invention provides sustainability and/or integrity, backward traceability, and/or comparability. While existing approaches may merely include an ability to reposit data, in embodiments of the present invention, the model generated by the program code as well as the data linkages determined by the program code are sustainable between combined data assets across industries, regions and time. The program code maintains this sustainability by utilizing a distributed computing system (e.g., cloud) based backup-knowledge repository that includes self-healing AI capabilities to mutate algorithms and adjust roles of parameters if links to external data are broken.

As discussed herein, embodiments of the present invention comprise a system, method, and computer program product that create and operate an AI-driven intelligent workflow for maturity assessment of ecosystem-enabled innovation. To evaluate process maturity, program code in embodiments of the present invention uses exponential technologies and analytical tools to: 1) design and build a capability to create and maintain a hardened corpus of underlying data; 2) set up core foundational ecosystem-enabled innovation maturity model with an initial pilot; 3) make the model available to process users (e.g., deploy the model; 4) govern data (data governance, data capabilities, data availability, and data use and impact) including to ensure privacy and compliance; 5) automatically validate participants and data (e.g., to ensure data quality by evaluating completeness, accuracy, and/or lack of bias); 6) continually expand and improve the data corpus, maturity and analytical models; and/or 6) ensure model sustainability and the ability to reposit data. The program code in embodiments of the present invention ultimately provides a current (at all times) view of requirements for successful open innovation in current and in future environments. Utilization of embodiments of the present invention provide an opportunity for organizations to assess the maturity of their own capabilities and performance against their requirements. Thus, the program code can provide a path to build or improve the open innovation capabilities of a given organization or group of organizations.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

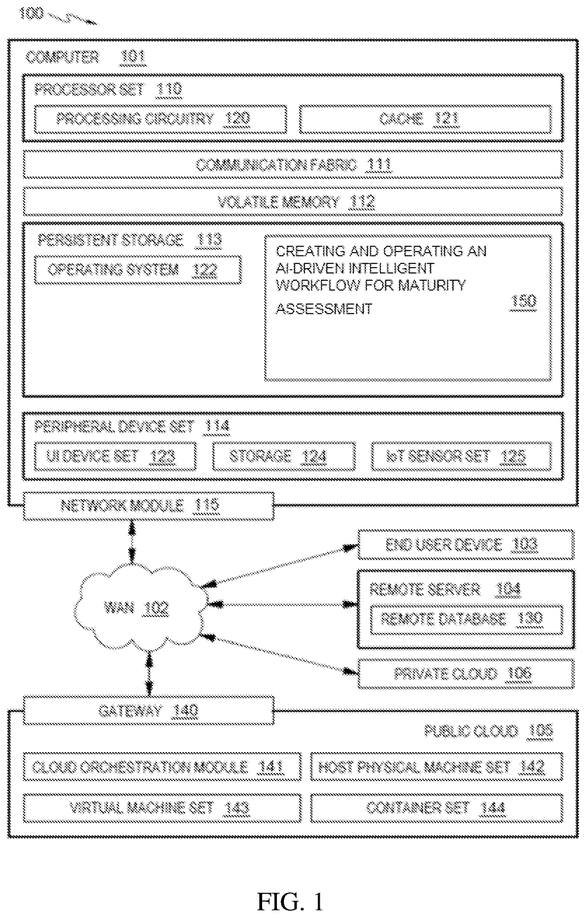

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as a code block for creating and operating an AI-driven intelligent workflow for maturity assessment of ecosystem-enabled innovation, which can include designing and building a capability to create and maintain a hardened corpus of underlying data, setting up a core foundational ecosystem-enabled innovation maturity model with an initial data set (e.g., training data), deploying the model for broader participation, governing data collection (e.g., to ensure privacy and compliance), automatically validating participants (to whom the model was deployed) and data (e.g., to ensure data quality including completeness, accuracy and lack of bias), continuously expand and improve the data corpus, maturity and analytical models, and ensure model sustainability and repositing of data 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

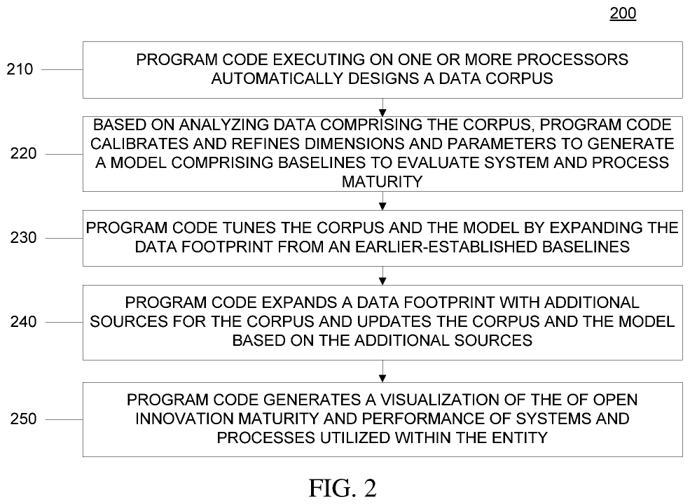

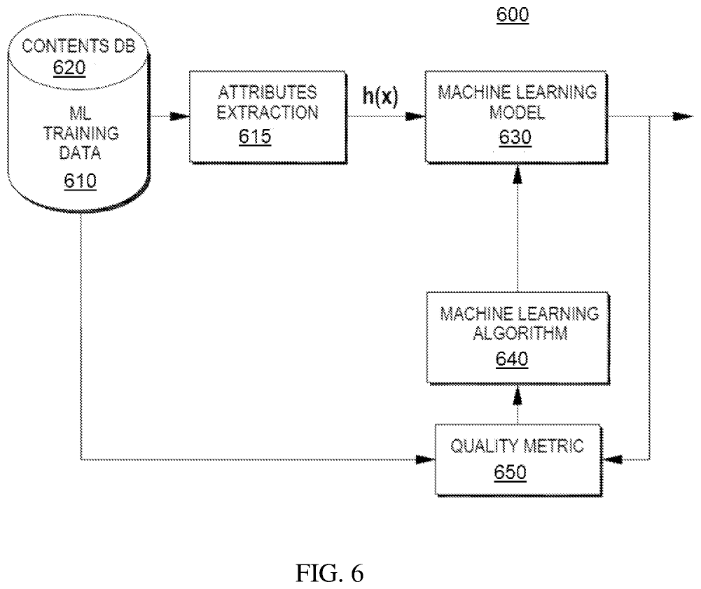

FIG. 2 is a workflow 200 that provides an overview of various aspects of some embodiments of the present invention. As illustrated in the workflow, the program code initially establishes an ability to use various aspects of AI to identify potential participants and data sources and recruit participation (e.g., designing a data corpus and building an initial model with key parameters) (210, 220). FIG. 6 illustrates a classifier in a neural network (NN) that can be generated by the program code. A classifier in a NN can be generated and utilized by the program code to identify key parameters. The program code then tunes the corpus and the model by expanding the data footprint from these earlier-established baselines (e.g., corpus, initial model) (230). The program code continues to refine (e.g., expand and improve) the model and the corpus as the model is applied over various organizations (240). At any time, the program code can generate and deliver an assessment of an entity in the ecosystem based on a most current version of the model (250). As discussed in the 200, program code in embodiments of the present invention applies a range of statistical methods to a corpus of primary and secondary research data, augmented with external research identifying the changing parameters of maximum importance for successful open innovation and attributes of successful organizations, as input to define, continuously, dynamically, and iteratively refine, update, and expand: maturity model specifications and parameters, scoring and weighting of questions used to facilitate data collection, and assessment and progression criteria (by tracking interdependencies/overlaps between model elements over time, including discontinuities).

In this example, program code executing on one or more processors automatically designs a data corpus (210). The program code designs and builds a capability to create a hardened corpus of underlying data. The sources comprising the corpus include both individuals and databases. The program code automatically identifies source inputs for the corpus, including but not limited to primary original research, external research, SME experience, academics, publications, client engagements, regulatory agencies, and/or policies. This aspect is automatic because the program code utilizes AI-based recruitment and automated sourcing of inputs to establish the data corpus. The program code utilizes AI (including existing tools) and automation to identify organizations to target from which to obtain data for use in an initial set of training data. In some examples, the program code utilizes natural language understanding (NLU) to assist the AI in searching and identifying potential survey and/or model participants and sources of data and information (e.g., to identify paths and approaches to recruit and/or convert potential participants). The program code can also utilize various natural language generation (NLG) algorithms to optimize approaches and nomenclature to facilitate engagement by the identified participants.

As part of designing the corpus (210), the program code connects to the sources identified utilizing the AI (e.g., the AI can be provided with pre-defined parameters and business rules to utilize to identify the sources). Depending on the data source, the program code can utilize various methods to connect and access the data (e.g., application programming interfaces (APIs), queries, downloads to local memory accessible to the one or more processors executing the program code, etc.). Data sources identified by the program code can include, but are not limited to, regulatory agency and company databases, academic institutions, research organizations, news outlets, internal data repositories etc. Some of the data identified by the program code can be structured and unstructured and the program code can process certain of the data to make them accessible in the data corpus. For example, the program code can utilize natural language processing (NLP) for documents, including but not limited to, contracts, company news, financial statements, patents, research publications, and/or policy documents in order to ingest the data in these documents.

Once the program code has identified and connected to the sources, the program code can make a record of the sources, in order to understand the contents of the present corpus. In some examples, the program code can register each source, including each participating organization (sources include organizations as well as databases) on a blockchain. A blockchain is a distributed database that maintains a continuously growing list of ordered records, called blocks. These blocks are linked using cryptography and each block contains a cryptographic hash of the previous block, a timestamp, and transaction data. Because of the dynamic nature of the examples described herein, utilizing a blockchain rather than a more traditional database provides flexibility. The program code can continuously refine the corpus by deploying smart contracting to initiate participation and joint inspection and review of data as it is ingested in real time.

Smart contracts are programs stored on a blockchain that run when predetermined conditions are met. In the context of the embodiments of the present invention, they are utilized to secure participation of entities in the maturity assessment. Smart contracts automate the execution of an agreement so that all participants can be immediately certain of the outcome, without any intermediary's involvement or time loss. Thus, parties can be bound to provide feedback utilizing smart contracts. Smart contracts work by following simple “if/when . . . then . . . ” statements that are written into code on the blockchain. A network of computers executes the actions when predetermined conditions have been met and verified. The blockchain is updated when a transaction is completed. A transaction cannot be changed and only parties who have been granted permission can see the results. The program code can automatically generate smart contracts in embodiments of the present invention. Thus, in some examples, program code can continuously refine the corpus by deploying smart contracting to initiate participation and joint inspection and review of data as it is ingested in real time. The program code can utilize validation loops and dynamic smart contracting to pause data ingestion when the program code determined that data is missing and/or incomplete. The program code (e.g., during the pause) can automatically send a request for a complete and/or corrected data.

Returning to FIG. 2, the program code calibrates and refines dimensions and parameters of a model (e.g., based on data provided by SMEs and potentially additional sources) (220). The program code implements a core foundational ecosystem-enabled innovation maturity model with an initial pilot (e.g., set of training data and/or designated user population). The program code utilizes AI to combine inputs and data from multiple sources and to convert these data to generate maturity framework parameters. The AI utilized by the program code to calibrate and refine the dimensions of the model can include a neural network (NN). The program code can utilize the NN to identify key parameters of importance for successful ecosystem-enabled innovation. The program code can translate these analytical findings into key parameters of maximum importance for the maturity framework (e.g., the model). The program code can utilize the results on the NN analysis to expand and characterize (scope and composition) parameters identified.

To identify key parameters of importance for successful ecosystem-enabled innovation, in certain embodiments of the present invention, the program code utilizes supervised, semi-supervised, or unsupervised deep learning through a single- or multi-layer NN to correlate various attributes from unstructured and structured data from the data corpus. The program code utilizes resources of the NN to identify and weight connections from the attribute sets in the data gathered. For example, the NN can identify certain data that are indicative of parameters responsible for performance metrics of various resources or processes that are outside of an expected range. In this way, the program code can generate a model that can classify processes as achieving organizational objectives, in real-time, based on utilizing patterns that the program code identifies in the data corpus.

As understood by one of skill in the art, NNs are a biologically inspired programming paradigm that enable a computer to learn from diverse data sets, including the sources identified as being part of the corpus in embodiments of the present invention. This learning is referred to as deep learning, which is a set of techniques for learning in NNs. Neural networks, including modular NNs, are capable of pattern recognition with speed, accuracy, and efficiency, in a situation where data sets are multiple and expansive, including across a distributed network of the technical environment. Modern NNs are non-linear statistical data modeling tools. They are usually used to model complex relationships between inputs and outputs or to identify patterns in data (i.e., NNs are non-linear statistical data modeling or decision-making tools). In general, program code utilizing NNs can model complex relationships between inputs and outputs and identify patterns in data. Because of the speed and efficiency of NNs, especially when parsing multiple complex data sets, NNs and deep learning both provide assistance in parsing both structured and unstructured data across multiple resources in a technical environment. Thus, by utilizing an NN, the program code can obtain parameters and can classify these parameters as key parameters for successful ecosystem-enabled innovation.

Thus, in some embodiments of the present invention, the program code can utilize an NN together with NLP and NLU to scan, for example (e.g., in secondary research/text/information) to identify main parameters of importance for ecosystem-enabled innovation. The program code can perform this process continuously, for example, on publicly available information (e.g., comprising the corpus) to identify latest trends in ecosystem-enabled or open innovation.

Returning to FIG. 2, the program code generates an initial model (220). To generate this model the program code builds and operationalizes parameters (e.g., specific questions) and utilizes the parameters to develop and align a consistent maturity scale across the questions and/or components. The program code provides an automated conversion of data (from the corpus) to parameters, capability statements (from the NN analysis) and operationalizes these capability statements (e.g., converts the capability statements into questions). The program code can utilize NLP to ingest the data (e.g., the key parameters) and NLU to perform a search to determine a context of an ecosystem-enabled innovation (e.g., the market, industry), based in part by the key parameters identified earlier. Once the program code determined the context of the key parameters, the program code can convert the parameters into capability statements (e.g., utilizing NLG), and the program code can also utilize NLG to convert capability statements into questions (e.g., generate questions) that the program code can utilize to facilitate engagement and data gathering. The program code can electronically disseminate the questions to systems and participants identified by the program code.

As part of generating the model (220), the program code refines the model. Data ingestion and refinement of parameters based on this ingestion is ongoing and thus, many of the processes the program code uses to refine the model were utilized by the program code to generate the initial model. The program code can refine the model by recalibrating and further defining portions of the model (based on SMEs, data from other entities including research partners, additional training data, etc.). The program code formulates scoring and weighting, which includes interdependencies and progression criteria. The program code can utilize AI aspects to automate and continuously and iteratively refine the maturity of the model. The program code continuously ingests data from the data sources (e.g., the data corpus) using tools such as NLP. The program code can also utilize NLU to perform an AI-assisted search to identify potential participants and other inputs. (As noted above, data utilized by the program code can come from individuals, groups of individuals, and/or repositories). To drive engagement (because the model improves based on feedback), the program code can utilize NLG to optimize approaches and nomenclature to facilitate engagement with the program code (and the model). Because the program code registers the sources that it utilizes, the program code can register the sources (participants, organizations) in a blockchain. This refinement aspect can also include the program code utilizing dynamic smart contracting, which can pause data ingestion for inspection and/or validation before it is ingested by the model. This pause provides quality assurance.

As aforementioned, the program code can utilize a NN to identify relationships between data points in the corpus and from other sources. As much, the program code can build analytical tools (algorithms, data models) to score and weight the questions and the tracking of interdependencies. The program code, based on the relationships discovered utilizing the NN, can generate graphs to view different vectors of analysis to visualize a degree of overlap between elements and/or the extent of common coverage. The view of this analysis (e.g., a cube analysis that visualizes 2, 3, and/or 4-dimensional interdependencies) changes over time. Based on these changes over time, the program code can provide a view of components of an organization and identify what areas are covered (e.g., are mature), and whether they interlock or overlap.

Another advantage of embodiments of the present invention is that providing additional data to the model is simplified such that data is continuously collected by the program code based on an open standard such that analysis can continue. To determine whether area are mature, the program code can generate a survey instrument (with the aforementioned questions) for primary empirical research and utilize the results of this research to define performance metrics. The program code collects these data utilizing a cloud-based data collection. By utilizing an automated data collection with an open standard, participation is enabled via multiple channels. Connection points to program code in examples herein for data collection can include, but are not limited to mobile applications (e.g., via mobile phones, tablets, desktops etc.) and backend (passive data collection) application (e.g., by integrating application to a data and/or analytical engine). Thus, both active and passive data collection can be automated in embodiments of the present invention.

In embodiments of the present invention, as the program code automatically collects additional data to tune its model and criteria (e.g., to accurately determine maturity of processes in view of business interests), the program code ensures the integrity of the data collected. For example, the program code can assign a universal identifier to each data source and enables the integration of external data with data from internal sources. By integrating these identifiers across data sets, the program code can create linkages to other data sets through the universal identifier to allow for integration of maturity model data for individual respondents with other data sets. The program code tracks additions and changes over time and across various parameters, including, but not limited to, geographical areas, roles, and/or responsibilities.

The program code tunes the corpus and the model by expanding the data footprint from these earlier-established baselines (e.g., corpus, initial model) (230). As such, the program code makes the maturity model available for broader participation. This process can be understood as hardening aspects of some embodiments of the present invention. Utilizing the aforementioned distributed deployment (e.g., cloud-based deployment), the program code makes the model and corpus available to relevant entities (e.g., organizations). The program code identifies survey or benchmark participants and the scope (breadth and depth) of data. The program code builds a data foundation through by deploying a survey instrument (e.g., using research partner or other portal), iterating regularly to ensure data quality. The program code validates the model utilizing various statistical approaches (e.g., to analyze incoming data and continuously analyze data points and dependencies). The program code can analyze both internal and external data by applying various analytical models, including but not limited to, neural nets.

The program code continually, automatically, and iteratively expands and improves the maturity model, analytical models and the data corpus. As discussed earlier, the dynamism of the model provides an advantage over existing maturity assessment models for open ecosystems (e.g., ever-expanding technical environments). Thus, by providing the model with access to the technical infrastructures of additional organizations, the program code can refine (e.g., expand and improve) the model and the corpus (240). Thus, it is desirable to seek to deploy the systems and methods described herein to other organizations (e.g., including ecosystem partners) to amplify application and use. Furthermore, at a strategic level, organizations have realized and acknowledged that to survive, they must be willing to partner with organizations and individuals throughout their ecosystems. The resulting collaborative approaches to value-creation, enabled by accelerated cloud adoption and open technology architectures, are not captured in current open innovation maturity models and frameworks. Aspects of embodiments of the present invention are improved by widespread adoption. Expanding the user base (e.g., the users in target populations) will expand data foundation (e.g., breadth, depth and reach of surveying to expand data footprint). As the available data expands, the program code will continue to continuously and iteratively update analytical models based on new data and insights (including use of neural nets). The program code will also continuously and iteratively update open standard framework, including but not limited to assessment criteria, dependencies, progression criteria, and/or comparators (e.g., personas etc.).

The program code can automatically re-baseline the model with governing checks and balances. The program code can utilize AI to search publicly available data to track trends and changes in parameters important for open innovation. The results of this search will impact the previously determined key parameters and should the program code identify discrepancies, it can automatically update existing parameters (excluded or change these parameters) and/or add new parameters. The program code can analyze internal and external data sources to determine when an element is no longer an innovation but has normalized to industry standard. The program code can then automatically reset to a new baseline based on updated data through time, and iterative calibration of parameters. The program code can automatically repair (e.g., self-heal) the model to reflect any changes in relationships and dependencies and can make automatic updates to model as new data is added and the model re-baselined.

As the model is tuned, the program code can test the integrity of the model using backward traceability and comparability. The increased use of the model not only improves the model, this increased usage also creates options for monetization. To monetize the model, the program code can utilize the trained algorithms (AI) to create and target premium priced services and insights options for users and can target tailored premium services to participants (including but not limited to detailed or tailored insights, consulting services etc.).

Utilizing the workflow 200 of FIG. 2, the program code in embodiments of the present invention can: 1) provide a comprehensive and always-current view of what is required for successful open innovation today and in future; 2) provide an opportunity for organizations to assess the maturity of their own capabilities across four domains, including ecosystem-enabled innovation strategy and culture, external capability, internal capacity, and technology enablement, as well as the performance of these capabilities against the above requirements; 3) provide an ability for organizations to benchmark their capabilities and performance against that of peers, including but not limited to those in the same industry, region, company size, profile, open innovation persona etc.; and 4) provide a path to build or improve open innovation capabilities (for individual companies or clusters of organizations, including but not limited to those in a particular industry, region, company size, profile, open innovation persona etc.).

Because the model and the corpus are continuously updated, at any time, the program code can generate a comprehensive and dynamically updated view of open innovation maturity and performance of systems and processes utilized within an entity comprising the ecosystem. The program code applies the model to an entity in the ecosystem and based on the most recent version of the model, the program code generates a visualization of the of open innovation maturity and performance of systems and processes utilized within the entity (250). The program code can obtain this request via a user interface and/or it may general a new request at various intervals, based on pre-configured attributes. The program code can provide the results to a user via an interface of a device accessible via the distributed computing system (e.g., cloud computing system) upon which the model was deployed.

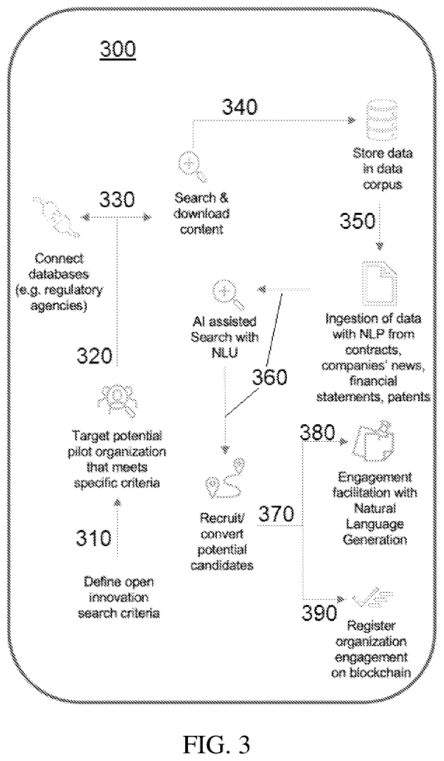

FIG. 3 is a combination of a data flow and a technical aspect diagram 300 which illustrates how in various embodiments of the present invention the program code continuously sources inputs for expansion of the corpus (and to tune the maturity model). As illustrated in FIG. 3, program code executing on one or more processors, defines open innovation search criteria to target organizations for participation in an initial group based in members of the initial group meeting pre-defined criteria (310). The initial group can be considered a pilot and the data collected during this phase can be considered training data for the maturity assessment model. The initial group can include, but is not limited to, organizations (or individuals) with specific skills, knowledge, experience, from specific regions, company types, industries, and who have achieved pre-defines financial and operational performance measures, etc. The program code targets entities from the defined initial group (320). The program code communicatively connects to sources of digitized data and information (e.g., to regulatory agencies and company databases) belonging to and/or utilized by members of the initial group (330). The program code generates a corpus by extracting and/or data from the data sources (340). To access the data the program code can utilize various connection methods including, but not limited to, performing document searches and downloading content from sources. These sources relevant to members of the initial group can include academic institution resources, research organizations resources, news outlet resources, and/or internal data repositories. The program code establishes a data corpus (350). The corpus can contain some of the data. The corpus can also include links to locations where various data reside.

The program code ingest data from the corpus (so that it can utilize an NN to find linkages between the data and identify prevalent attributes) such that it can identify potential survey and/or model participants and sources of data and information (360). As discussed in FIG. 2, the program code can employ NLP and NLU in order to manage and ingest the data and to assist in searching the data. Ingesting the data also enables the program code to identify paths and approaches to recruit and/or convert potential participants (370). As explained above, the model can determine maturity based on participation of various organization in an open framework and additional data sources assist in tuning the model and processes. After identifying potential participants, the program code can engage the participants (people, sources, organizations) by optionally utilizing NLG to optimize approaches and nomenclature to facilitate engagement (380). The program code registers each participant and data source in a repository (e.g., on a blockchain) (390).

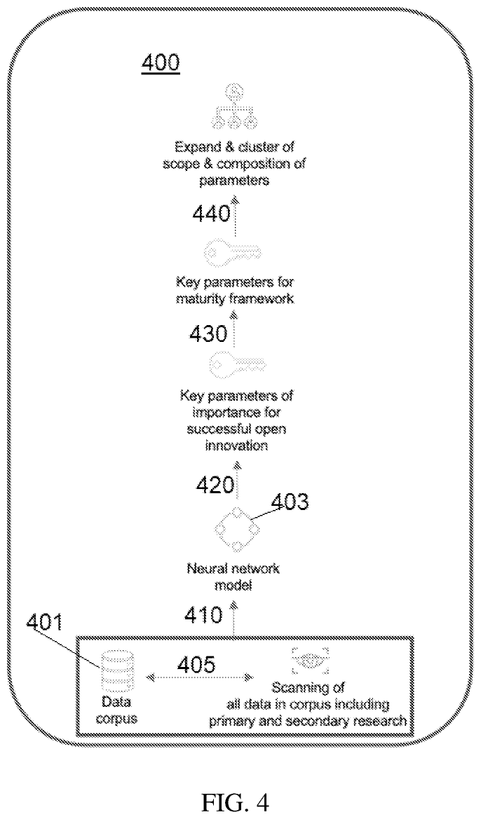

FIG. 4 is a combination of a data flow and a technical aspect diagram 400 which illustrates aspects of some embodiments of the present invention by which the program code continuously iterates various aspects and as such improves and extends the maturity model to evaluate an extended ecosystem more effectively. The program code obtains inputs and data from the corpus (e.g., linkages between data and data) and converts the inputs to framework parameters. The corpus comprises both primary and secondary data. In the illustrated example, the program code scans data in the data corpus 401 (e.g., secondary research/text/information in the data corpus). The program code can utilize NLP to process the contents of the corpus more efficiently and NLU to contextualize the data discovered during NLP of the secondary source data (e.g., to understand the context of ecosystem-enabled innovation, the market, industry, etc.) (405). The program code utilizes an NN 403 to analyze primary data in the corpus 401 (410). The program code translates the results of this analysis into key parameters of maximum importance for maturity framework (420, 430). As explained above, the data sources and the content of the corpus can expand as additional sources and participants are identified, and the open ecosystem being analyzed is expanded. Thus, the program code repeats the scanning and the identification of key parameters (revising these as data changes). As the program code expands and changes the scope and composition of the ecosystem upon which it is conducting a maturity analysis, the program code updates the key parameters based on most current analytical findings (440). Thus, the ecosystem, the cluster comprising the scope, and the composition of the parameters are dynamic.

As explained in FIG. 2, once the program code has identified the parameters for a maturity framework, the program code converts the parameters into capability statements and converts capability statements into questions. The program code can utilize NLG to generate survey questions to facilitate engagement and data gathering. The program code develops, maintains, and refines scoring and weighting of these maturity model questions (e.g., based on industry norms and standards, which the program code machine learns). The program code continues to track interdependencies and overlaps. To track these interdependencies, the program code can utilize an NN and various existing technologies to generate cube analyses to view, in 2, 3, and 4 dimensions, the interdependencies by looking at the components of an organization and identifying what areas are covered, and whether they interlock or overlap. The program code can also utilize various visualization tools to generate graphs to view different vectors of analysis to understand the degree of overlap between elements and/or the extent of common coverage). The program code, because the model is dynamic, defines, refines and maintains an assessment and progression criteria. As also discussed in FIG. 2, the program code can deploy smart contracting to initiate participation and joint inspection and review of data as it is ingested in real time.

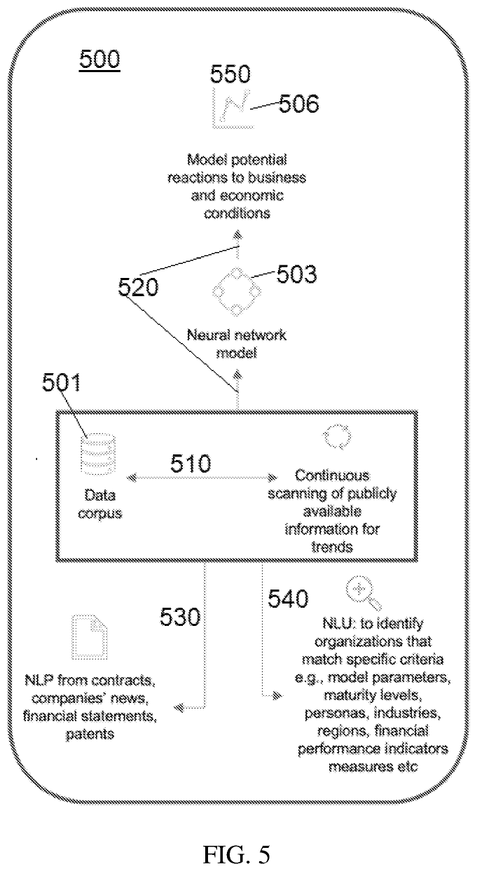

FIG. 5 is a combination of a data flow and a technical aspect diagram 500 which illustrates aspects of some embodiments of the present invention by which the program code augments data available to the processes (e.g., in the corpus) with external data for continuous, iterative improvements and extension of the model (the maturity model generated and continuously tuned by the program code). Referring to FIG. 5, the program code continuously scans publicly available information, including, but not limited to, articles on the Internet, to identify latest trends in ecosystem-enabled or open innovation. The program code utilizes the insights gleaned (utilizing machine-learning NLP and NLU) to identify emerging and new trends in ecosystem-enabled innovation (e.g., the role of new technologies) to enable ongoing improvement and extension of analytical and maturity models, including discontinuities (510). The program code can evaluate economic information (included by utilizing a NN 503) and model reactions to business and economic conditions (520). To that end, the program code evaluates data sources including, but not limited to, business news, companies' financial statements, public remarks from earnings calls, policy statements or annual reports, etc. The program code can utilize the NN to categorize elements of these data sources while applying NLP for information discovery (530). To expand the scope of the ecosystem (in order to determine a more inclusive view of maturity) the program code identifies organizations that match specific criteria (e.g., model parameters, maturity levels, personas, industries, regions, financial performance indicators, measures etc.) (540). The program code can utilize NLP and NLU to make these identifications. Once similar organizations can be identified, parameters and data sources relevant to these organizations can be incorporated into the model and corpus. The program code can perform a wide range of analyses with novel vectors of data collected. The program code, with the expanded data set, can identify factors that create or inhibit innovation and value creation for the identified organizations. The program code can utilize an NN 503 to expand insights into the relative importance of different parameters and how that will influence innovation over time and determine and/or identify external influences. These determinations enable continuous model updates. The program code can visualize various findings, for example the program code can generate a model 506 of potential reactions to business and economic conditions, including unanticipated population conditions that can affect economies, to enable continuous improvement and extension of analytical and maturity models, including discontinuities (550).

Although expanding the data and scope can potentially improve the corpus and the model (and hence, the analyses performed utilizing the model), for inclusion in the system and methods described herein, the program code can evaluate the data to determine the value of potential source. The program code can identify value-creation opportunities, define paths to capture these opportunities for a variety of scenarios and predict potential realized value and identify the most probable pathways to innovation. The program code automatically recommends pathways as inputs to recommendations at both an industry level and/or at an individual company level. These recommendations can enable these entities to build or mature their capabilities.

The program code generates and trains the maturity model on resources comprising the corpus, to identify key parameters for a maturity framework. FIG. 6 is one example of a machine learning training system 600 (also referred to as an AI system) that may be utilized, in one or more aspects, to generate and train a maturity model to identify key parameters of importance for successful open innovation and key parameters for the maturity framework. The program code can be trained to classify attributes or data points found in resources in the corpus as key parameters or as not being significant (e.g., industry standard) to assess maturity in an ecosystem. FIG. 6 is one example of a machine learning training system 600 that may be utilized, in one or more aspects, to perform cognitive analyses of various inputs, including primary and secondary data in the corpus. The program code in embodiments of the present invention performs a cognitive analysis to generate one or more training data structures, including the maturity models, which can include algorithms utilized by the program code to classify an attribute as a key parameter. Machine learning (ML) solves problems that are not solved with numerical means alone. In this ML-based example, program code extracts various attributes from ML training data (e.g., the corpus). These attributes 615 are utilized to develop a predictor or classifier function, h(x), also referred to as a hypothesis, which the program code utilizes as a machine learning model 630.

In identifying various key parameters in the ML training data 610, the program code can utilize various techniques to identify attributes in an embodiment of the present invention. Embodiments of the present invention utilize varying techniques to select attributes (elements, patterns, features, components, etc.), including, but not limited to, diffusion mapping, principal component analysis, recursive feature elimination (a brute force approach to selecting attributes), and/or a Random Forest, to select the attributes related to various processes. The program code may utilize a machine learning algorithm 640 to train the machine learning model 630 (e.g., the algorithms utilized by the program code), including providing weights for the conclusions, so that the program code can train the predictor functions that comprise the machine learning model 630. The conclusions may be evaluated by a quality metric 650. By selecting a diverse set of ML training data 610, the program code trains the machine learning model 630 to identify and weight various attributes (e.g., features, patterns, components) that correlate to various parameters.

The model generated by the program code can be self-learning as the program code updates the model based on active event feedback, as well as from the feedback received from data related to the event. For example, when the program code determines that there is information that was not previously predicted or classified by the model, the program code utilizes a learning agent to update the model to reflect the resource type, to improve classifications in the future. Additionally, when the program code determines that a classification is incorrect, either based on receiving user feedback through an interface or based on monitoring related to the process (related to the parameter), the program code updates the model to reflect the inaccuracy of the classification for the given period of time. Program code comprising a learning agent cognitively analyzes the data deviating from the modeled expectations and adjusts the model to increase the accuracy of the model, moving forward.

Embodiments of the present invention include a computer-implemented method, a computer system, and a computer program product of automatically generating and implementing a dynamic maturity model to generate a visualization of open innovation maturity and performance of systems and processes utilized by an entity in an ecosystem. In certain of the examples herein, program code executing on one or more processors in the ecosystem generates a data corpus based on discovering data sources accessible to the one or more processors, in the ecosystem. The program code analyzes data comprising the data corpus to identify key parameters defining maturity and performance of a pre-defined level of efficiency. The program code generates a model to evaluate the open innovation maturity and the performance of the systems and the processes utilized by the entity. The program code continuously expands a data footprint of the ecosystem based on accessing additional data sources, wherein expanding the ecosystem provides a portion of data in the additional data sources to the corpus. The program code updates the model to a most current version of the model, based on the expanding. The program code generates a visualization of the open innovation maturity and the performance of the systems and the processes utilized by the entity in an ecosystem based on applying the most current version of the model.

In some examples, the program code discovering the data sources accessible to the one or more processors further comprises the program code providing and artificially intelligent algorithm with pre-defined parameters and business rules and utilizing the artificially intelligent algorithm to discover the data sources.

In some examples, the program code generating the data corpus further comprises: processing, data comprising the data sources, the processing comprising: the program code utilizing, natural language processing to extract attributes from the data.

In some examples, the program code generating the data corpus further comprises: the program code registering the data sources and each entity comprising the ecosystem on a blockchain.

In some examples, the program code generates and deploys smart contracts to each entity comprising the ecosystem. The program code records the smart contracts on the blockchain.

In some examples, the program code processing the data comprises ingesting the data in real-time. In some examples, the smart contracts initiate participation and joint inspection and review of the ingested data.

In some examples, the program code determines, based on participation from an entity comprising the ecosystem in validating the data, that there is an issue with various data of the data. The program code pauses the ingesting. Based on the pausing, the program code requests that the entity resolve the issue with the various data. The program code obtains additional data to resolve the issue. Based on the obtaining, the program code resumes the ingesting.

In some examples, the issue with various data is selected from the group consisting of: missing data and incomplete data.

In some examples, the program code generating the model comprises: the program code utilizing, a neural network, to identify analytical findings comprising key parameters of importance for successful ecosystem-enabled innovation, and the program code converting, the analytical findings into key parameters of the model.

In some examples, the additional data sources comprise publicly available information.

In some examples, the program code generating the model further comprises: the program code automatically converting, the key parameters into survey questions, the program code deploying, the survey questions to users of the ecosystem, the program code obtaining, feedback based on the survey questions, and the program code automatically updating, the model based on the feedback.

In some examples, the program code generates, based on applying the neural network, scores and weights for the key parameters.

In some examples, the program code continuously expanding the data footprint of the ecosystem further comprises: the program code identifying potential entities and potential data input, and the program code selecting a portion of the potential entities and a portion of the potential data inputs based on comparing the potential entities and the potential data inputs with one or more entities utilizing the ecosystem.

In some examples, a portion of the additional data sources comprise data sources external to the ecosystems and updating the model comprises repairing broken linkages between data comprising the sources external to the ecosystems and the data comprising the data sources.

In some examples, the program code generates a back-up knowledge repository. The back-up knowledge corpus can comprise linkages between the model and the data in the data corpus. The back-up knowledge repository can comprise self-healing capabilities.

In some examples, the program code facilitates, the self-healing capabilities, the facilitating comprising: the program code determining that one or more linkages of the linkages between the model and the data are broken, and the program code adjusting, one or more roles of at least one key parameters of the key parameters to repair the one or more linkages.

In some examples, the program code determines that a threshold weight of changes has been achieved, based on comparing the data to at least one weight for a key parameter of the key parameters, wherein the at least one weight for the key parameter comprises a baseline value. The program code automatically updates the baseline value, based on the weight of the changes.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of automatically generating and implementing a dynamic maturity model to generate a visualization of open innovation maturity and performance of systems and processes utilized by an entity in an ecosystem, comprising:
generating, by one or more processors in the ecosystem, a data corpus based on discovering data sources accessible to the one or more processors, in the ecosystem;
analyzing, by the one or more processors, data comprising the data corpus to identify key parameters defining maturity and performance of a pre-defined level of efficiency;
generating, by the one more processors, a model to evaluate the open innovation maturity and the performance of the systems and the processes utilized by the entity;
continuously expanding, by the one or more processors, a data footprint of the ecosystem based on accessing additional data sources, wherein expanding the ecosystem provides a portion of data in the additional data sources to the corpus;
updating, by the one or more processors, the model to a most current version of the model, based on the expanding; and
generating, by the one or more processors, a visualization of the open innovation maturity and the performance of the systems and the processes utilized by the entity in an ecosystem based on applying the most current version of the model.

2. The computer-implemented method of claim 1, wherein discovering the data sources accessible to the one or more processors further comprises:
providing, by the one or more processors, an artificially intelligent algorithm with pre-defined parameters and business rules; and
utilizing, by the one or more processors, the artificially intelligent algorithm to discover the data sources.

3. The computer-implemented method of claim 1, wherein generating the data corpus further comprises:
processing, by the one or more processors, data comprising the data sources, the processing comprising:
utilizing, by the one or more processors, natural language processing to extract attributes from the data.

4. The computer-implemented method of claim 1, wherein generating the data corpus further comprises:
registering, by the one or more processors, the data sources and each entity comprising the ecosystem on a blockchain.

5. The computer-implemented method of claim 3, further comprising:
generating and deploying, by the one or more processors, smart contracts to each entity comprising the ecosystem; and
recording, by the one or more processors, the smart contracts on the blockchain.

6. The computer-implemented method of claim 5, wherein the processing the data comprises ingesting the data in real-time, and wherein the smart contracts initiate participation and joint inspection and review of the ingested data.

7. The computer-implemented method of claim 1, further comprising:
determining, by the one or more processors, based on participation from an entity comprising the ecosystem in validating the data, that there is an issue with various data of the data;
pausing, by the one or more processors, the ingesting;
based on the pausing, requesting, by the one or more processors, that the entity resolve the issue with the various data;
obtaining, by the one or more processors, from the entity, additional data to resolve the issue; and
based on the obtaining, resuming, by the one or more processors, the ingesting.

8. The computer-implemented method of claim 7, wherein the issue with various data is selected from the group consisting of: missing data and incomplete data.

9. The computer-implemented method of claim 1, wherein generating the model comprises:
utilizing, by the one or more processors, a neural network, to identify analytical findings comprising key parameters of importance for successful ecosystem-enabled innovation; and
converting, by the one or more processors, the analytical findings into key parameters of the model.

10. The computer-implemented method of claim 1, wherein the additional data sources comprise publicly available information.

11. The computer-implemented method of claim 10, wherein generating the model further comprises:
automatically converting, by the one or more processors, the key parameters into survey questions;
deploying, by the one or more processors, the survey questions to users of the ecosystem;
obtaining, by the one or more processors, feedback based on the survey questions; and
automatically updating, by the one or more processors, the model based on the feedback.

12. The computer-implemented method of claim 10, further comprising:
generating, by the one or more processors, based on applying the neural network, scores and weights for the key parameters.

13. The computer-implemented method of claim 1, wherein continuously expanding the data footprint of the ecosystem further comprises:
identifying, by the one or more processors, potential entities and potential data inputs; and
selecting, by the one or more processors, a portion of the potential entities and a portion of the potential data inputs based on comparing the potential entities and the potential data inputs with one or more entities utilizing the ecosystem.

14. The computer-implemented method of claim 1, wherein a portion of the additional data sources comprise data sources external to the ecosystems and updating the model comprises repairing broken linkages between data comprising the sources external to the ecosystems and the data comprising the data sources.

15. The computer-implemented method of claim 1, further comprising:
generating, by the one or more processors, a back-up knowledge repository, wherein the back-up knowledge corpus comprises linkages between the model and the data in the data corpus, and wherein the back-up knowledge repository comprises self-healing capabilities.

16. The computer-implemented method of claim 15, further comprising:
facilitating, by the one or more processors, the self-healing capabilities, the facilitating comprising:
determining, by the one or more processors, that one or more linkages of the linkages between the model and the data are broken; and
adjusting, by the one or more processors, one or more roles of at least one key parameters of the key parameters to repair the one or more linkages.

17. The computer-implemented method of claim 12, further comprising:
determining, by the one or more processors, that a threshold weight of changes has been achieved, based on comparing the data to at least one weight for a key parameter of the key parameters, wherein the at least one weight for the key parameter comprises a baseline value; and
automatically updating, by the one or more processors, the baseline value, based on the weight of the changes.

18. A computer system for automatically generating and implementing a dynamic maturity model to generate a visualization of open innovation maturity and performance of systems and processes utilized by an entity in an ecosystem, comprising:
a memory; and
one or more processors in communication with the memory, wherein the computer system is configured to perform a method, said method comprising:
generating, by the one or more processors in the ecosystem, a data corpus based on discovering data sources accessible to the one or more processors, in the ecosystem;
analyzing, by the one or more processors, data comprising the data corpus to identify key parameters defining maturity and performance of a pre-defined level of efficiency;
generating, by the one more processors, a model to evaluate the open innovation maturity and the performance of the systems and the processes utilized by the entity;
continuously expanding, by the one or more processors, a data footprint of the ecosystem based on accessing additional data sources, wherein expanding the ecosystem provides a portion of data in the additional data sources to the corpus;
updating, by the one or more processors, the model to a most current version of the model, based on the expanding; and
generating, by the one or more processors, a visualization of the open innovation maturity and the performance of the systems and the processes utilized by the entity in an ecosystem based on applying the most current version of the model.

19. The computer system of claim 18, wherein discovering the data sources accessible to the one or more processors further comprises:
providing, by the one or more processors, an artificially intelligent algorithm with pre-defined parameters and business rules; and
utilizing, by the one or more processors, the artificially intelligent algorithm to discover the data sources.

20. A computer program product for automatically generating and implementing a dynamic maturity model to generate a visualization of open innovation maturity and performance of systems and processes utilized by an entity in an ecosystem, comprising:
one or more computer readable storage media and program instructions collectively stored on the one or more computer readable storage media readable by at least one processing circuit to perform a method comprising:
generating, by the one or more processors in the ecosystem, a data corpus based on discovering data sources accessible to the one or more processors, in the ecosystem;
analyzing, by the one or more processors, data comprising the data corpus to identify key parameters defining maturity and performance of a pre-defined level of efficiency;
generating, by the one more processors, a model to evaluate the open innovation maturity and the performance of the systems and the processes utilized by the entity;
continuously expanding, by the one or more processors, a data footprint of the ecosystem based on accessing additional data sources, wherein expanding the ecosystem provides a portion of data in the additional data sources to the corpus;
updating, by the one or more processors, the model to a most current version of the model, based on the expanding; and
generating, by the one or more processors, a visualization of the open innovation maturity and the performance of the systems and the processes utilized by the entity in an ecosystem based on applying the most current version of the model.
